(19) United States
(12) Patent Application Publication
(10) Pub. No.: US 2018/0068584 A1
(43) Pub. Date: Mar. 8, 2018

(54) Method of Weight Control by Monitoring and Controlling Insulin Level

(71) Applicants: Charles Tuan Nguyen, Irvine, CA (US); Tu Song-Anh Nguyen, Irvine, CA (US)

(72) Inventors: Charles Tuan Nguyen, Irvine, CA (US); Tu Song-Anh Nguyen, Irvine, CA (US)

(21) Appl. No.: 15/259,043

(22) Filed: Sep. 7, 2016

(51) Int. Cl. G09B 19/00; G09B 5/14; G09B 5/02; G06F 19/00

(52) U.S. Cl. CPC G09B 19/0092; G06F 19/322; G09B 5/02; G09B 5/14

(57) ABSTRACT

A method of weight control by monitoring and controlling an insulin level of a user includes the steps of providing an insulin food guidance that categorizes different foods into an insulin spiked food group and an insulin non-spiked food group, and providing an eating guidance for the user to eat the food in the insulin non-spiked food group and not to eat the food in the insulin spiked food group for a predetermined weight losing time period. The foods in the insulin spiked food group spikes the insulin level of the user and the food in the insulin non-spiked food group do not spike the insulin level of the user. Therefore, the method focuses on insulin but not calories, such that the user is able to easily follow and complete the method for losing weight.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a weight control method, and more particularly to a method of weight control by monitoring and controlling insulin level, which is a non-diet method to control and maintain the user's weight by the insulin level.

### Description of Related Arts

Various dieting methods are well-known for treatment of obesity, diabetes, and high cholesterol. For example, a diet controlling method is provide a daily diet menu to calculate the calorie intake per day and try to lower the calorie intake than a daily calorie burned by the user. In other words, the user must initially calculate how much calories the user daily needs to consume by the information of the user, such as age, gender, height, weight, and daily activity. However, this assumption is not accurate because some factors, especially the daily activity, will change every day. In addition, the user must convert different food energies into corresponding calories. It is always a hassle for the user to calculate the overall calories from different foods before each meal. It is always a confusion for the user to determine how much food, such as 1 tablespoon of butter, can be eaten at each meal.

Another dieting method for losing weight is achieved by an oral dietary supplement. The user will take an oral dosage form, such as diet pills, daily to reduce and control the user's weight. However, such diet pills will have side effects of increased blood pressure and heart rate, insomnia, nervousness, blurred vision, restlessness, and/or headache. Therefore, before taking the diet pills, the user must have a body check by the doctor and most of the diet pills require doctor prescription.

The most effective weight losing method is workouts and exercises. The most common suggestion for losing weight is “eat less and exercise more”. However, different workout programs are designed for different users, wherein there is no one unique workout program being fitted for everyone. Accordingly, two factors that stop user from losing weight with exercise are boredom and injury. In fact, most users eat more after exercise.

There are two problems that all above weight loss programs face: (1) most people fail to follow and complete the programs. For example, It is hard for the user to only eat diet food everyday or to spend one hour a day for the workout program. (2) Most people reach a plateau and eventually gain back all the weight in 6-8 months.

### SUMMARY OF THE PRESENT INVENTION

The invention is advantageous in that it provides a method of weight control by monitoring and controlling insulin level, which is a non-diet method to control and maintain the user's weight by the insulin level.

Another advantage of the invention is to a method of weight control by monitoring and controlling insulin level, which is a program derived from scientific and psychotherapy principles that teaches the user how to apply biological principles of insulin to burn fat and lose weight; psychological principles of cognitive behavioral therapy (CBT) to change your thinking; and social behavioral techniques to break bad habits.

Another advantage of the invention is to a method of weight control by monitoring and controlling insulin level, which is a natural way for the user to lose weight and control weight without any side effect.

Another advantage of the invention is to a method of weight control by monitoring and controlling insulin level, which focuses on insulin but not calories, such that the user is able to easily follow and complete the program for losing weight.

Another advantage of the invention is to a method of weight control by monitoring and controlling insulin level, wherein there is no restriction to eating prescriptions, eating habits, or time of food consumption as long as the food will not spike the insulin level. In other words, the user may have as much as he or she wants and anytime he or she wants to eat the food without spiking the insulin level.

Another advantage of the invention is to a method of weight control by monitoring and controlling insulin level, which can help the user to overcome the weight loss plateau and to lose weight again. Therefore, the user can keep losing weight once the body reset the insulin level.

Additional advantages and features of the invention will become apparent from the description which follows, and may be realized by means of the instrumentalities and combinations particular point out in the appended claims.

According to the present invention, the foregoing and other objects and advantages are attained by a method of weight control by monitoring and controlling an insulin level of a user, comprising the following steps.

(1) Provide an insulin food guidance that categorizes different foods into an insulin spiked food group and an insulin non-spiked food group, wherein the foods in the insulin spiked food group spikes the insulin level of the user and the food in the insulin non-spiked food group do not spike the insulin level of the user.

(2) Provide an eating guidance for the user to eat the food in the insulin non-spiked food group and not to eat the food in the insulin spiked food group for a predetermined weight losing time period.

In accordance with another aspect of the invention, the present invention comprises a weight control package, comprising a bring down insulin level meal replacement which comprises food compositions belonging to an insulin non-spiked food group, wherein the food compositions in the insulin non-spiked food group do not spike an insulin level of a user, wherein the food compositions in the insulin non-spiked food group are selected from a group consisting of proteins and green, leafy vegetables that the user is able to eat the food compositions in the insulin non-spiked food group as much as the user wants and anytime the user wants for a predetermined weight losing time period.

In accordance with another aspect of the invention, the present invention comprises a weight control system, comprising:

a control center which comprises an online platform for different users as participants accessing through Internet; and

a teaching database provided on the online platform, wherein the teaching database includes an insulin food guidance that categorizes different foods into an insulin spiked food group and an insulin non-spiked food group, and an eating guidance for the user to eat the food in the insulin non-spiked food group and not to eat the food in the insulin spiked food group for a predetermined weight losing time period, wherein the foods in the insulin spiked food group spikes the insulin level of the user and the food in the insulin non-spiked food group do not spike the insulin level of the user.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram illustrating a method of weight control by monitoring and controlling an insulin level of a user according to a preferred embodiment of the present invention.

FIG. 2 is a block diagram illustrating a weight control system according to the above preferred embodiment of the present invention.

FIG. 3 illustrates a stoplight analogy of the insulin food guidance to indicate different food groups according to the above preferred embodiment of the present invention.

FIG. 4 is a graph illustrating the active-passive phase of the weight control method according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

High-fat, high-sugar foods get most of the blame for weight gain and obesity, but researchers have found that high insulin levels are actually the culprit. Accordingly, insulin plays a role in weight. Foods are broken down in the stomach from carbohydrates to glucose (sugar). The sugar then enters the bloodstream. This causes the pancreas to produce insulin that travels in the bloodstream to cells in the body. Insulin will bind to insulin receptors of brain, muscle and liver cells, telling the cells to absorb the glucose for energy use. The brain absorbs the least amount of sugar, followed by muscle cells and liver cells. However, these cells have a limited storage for glucose so the extra glucose eventually goes to the fat cells. Insulin signals the fat cells to take in glucose and stores it as fat while preventing the fall cells from burning fat. In short, when you eat foods that raise your insulin level, the body stores fat and doesn't burn fat; when you lower your insulin level, the body burns fat and doesn't store fat.

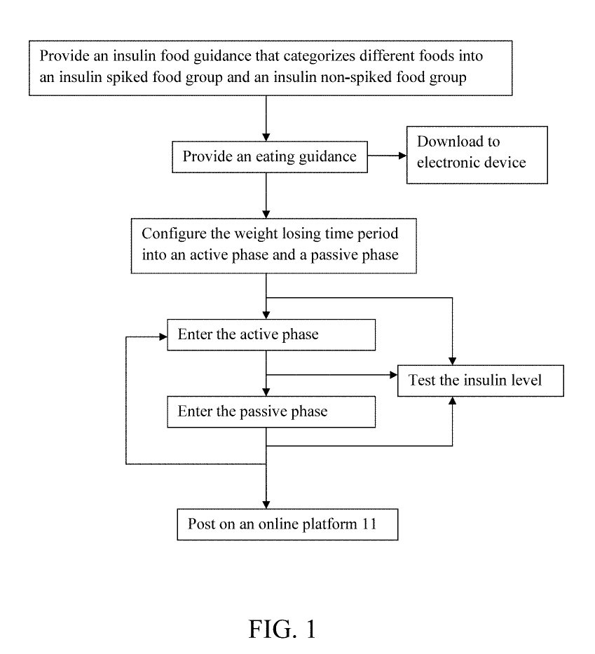

Referring to FIG. 1 of the drawings, a method of weight control by monitoring and controlling insulin level is illustrated according to a preferred embodiment of the present invention. Accordingly, the method of the present invention is a non-diet method, a non-calorie calculating method, and non oral drug administrating method. The method of the present invention is a natural way to lose weight by controlling an insulin level of a user by natural foods. In particular, the method of the present invention uses biological principles to optimize the insulin level of the user, wherein the method comprises the following steps.

(1) Provide an insulin food guidance that categorizes different foods into an insulin spiked food group and an insulin non-spiked food group.

(2) Provide an eating guidance for the user to eat the food in the insulin non-spiked food group and not to eat the food in the insulin spiked food group for a predetermined weight losing time period.

Accordingly, foods are categorizes into five different categories, that are sweets, grains, vegetables, fruits, and proteins. According to the present invention, the insulin food guidance categorizes different foods into three different groups, i.e. the insulin spiked food group, the insulin non-spiked food group, and an insulin caution food group. The foods in the insulin spiked food group spikes the insulin level of the user. The food in the insulin non-spiked food group do not spike the insulin level of the user. The foods in the insulin caution food group spike the insulin level of the user when the user eats more than one total portion per day.

The foods in the insulin non-spiked food group are selected from a group consisting of proteins and green, leafy vegetables. For example, proteins refer to meats (chicken, beef, or pork), fish or seafood, and egg whites. The foods in the insulin spiked food group are selected from a group consisting of sweets, grains, and starchy vegetables. The sweets refer to drinks, snacks and desserts. The starchy vegetables refer to potatoes, corns, carrots, beets, and the like. The foods in the insulin caution food group are selected from a group consisting of fruits and raw nuts. The fruits refer to apple, orange, grapes, berries, and the like. The user is able to eat the foods in the insulin non-spiked food group as much as the user wants and anytime the user wants. The user should not eat the foods in the insulin spiked food group and should avoid to eat the foods in the insulin caution food group (limit to only one portion a day).

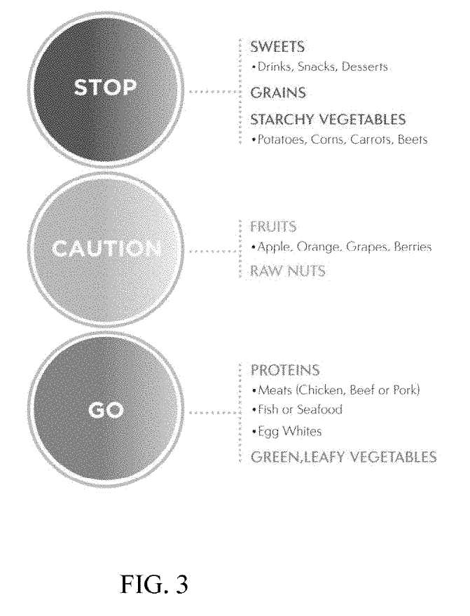

According to the preferred embodiment, the insulin food guidance uses a stoplight analogy to indicate different groups, as shown in FIG. 3. For example, “Red Light” group refers to the insulin spiked food group, “Yellow Light” group refers to the insulin caution food group, and “Green Light” group refers to the insulin non-spiked food group. Therefore, the user is able to check the food in one of the “Red Light” group, “Yellow Light” group, and “Green Light” in order to determine whether the food can be eaten or not. It is worth mentioning that the user will not feel hungry because he or she can eat as much as he or she wants, as long as the foods are in the “Green Light” group.

A common observation in a typical weight loss program is a plateau in body weight after several months of successful weight reduction. Most weight loss programs don't offer a solution to overcoming this plateau. Dieters become discouraged and return to the eating habits that created their weight problem in the first place.

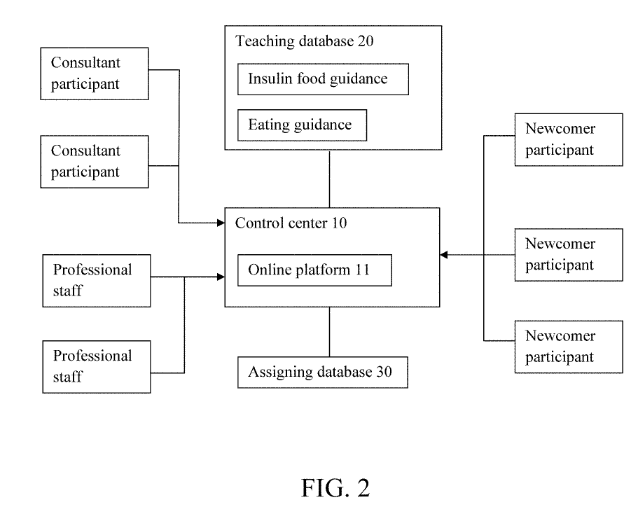

As shown in FIG. 2, the present invention also provides a weight control system, which is executed by a computerized device, comprising a control center 10 and a teaching database 20. The control center 10 is a web-based control center executed by a computerized device, wherein the control center 10 comprises an online platform 11 for different users as participants accessing through Internet. Each user is able to access the system by using an electronic device, such as computer, smart phone, tablet, or other Internet-enable devices. Preferably, each user is able to register to the system of the present invention through the online platform 11 to become the participant, wherein each participant is able to obtain his or her own unique identification number (ID number) from the system.

The insulin food guidance and the eating guidance are stored in the teaching database 20, wherein the user is able to access the online platform 11 to view the insulin food guidance and the eating guidance. In particular, the eating guidance is downloadable to the electronic device, preferably portable electronic device, to check the foods. The control center 10 also serves as a search engine that the user is able to input the food on the online platform 11, such that the control center 10 will generate the search result on the online platform 11 to indicate which group the food belonging to.

For simplifying the search result, the food will be indicated as one of the “Red Light” group, “Yellow Light” group, or “Green Light” group. Therefore, the user is able to easily check the food before the meal. For example, when the user input “potatoes”, the control center 10 will generate the search result of “Red Light” group on the online platform 11. Therefore, the user should not eat the “potatoes”.

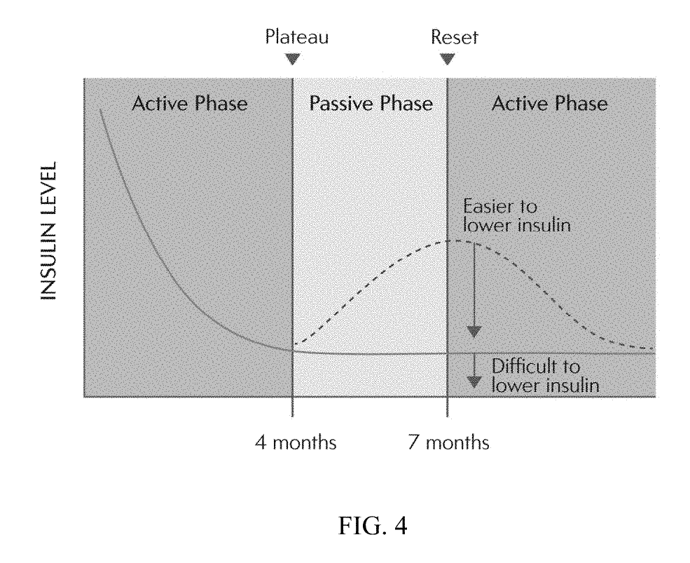

The present invention gives you a solution to the plateau by thinking in terms of insulin. As shown in FIG. 4, the insulin level remains low after the user has hit the weight-loss plateau after four months, as an example, after the user has started the program. It's difficult to lower the insulin level any further.

Therefore, if the user continues eating the same way the user is eating during the Active Phase of weight loss when the user hits the plateau, it's difficult for the user to lose any more weight once the body reset and allows the user to lose weight again.

But if you increase your insulin level after you hit the plateau during the Passive Phase of weight maintenance by eating controlled portions of grains or starchy vegetables for three months, you will be able to overcome this plateau and lose weight again. As shown in FIG. 4, the body will begin to burn fat because the insulin level is high enough for the user to lower it again when the user goes back to the Active Phase of weight loss.

In order to prevent the user reaches the plateau and eventually gain back the weight, the present invention configures the weight losing time period into an active phase and a passive phase, wherein the user is able to learn how to eat so that the user can raise the insulin level without gaining weight. The active phase is defined as a period that the insulin level of the user is brought down, and the passive phase is defined as a period that the insulin level of the user is slowly brought up after the active phase. In the active phase, the user is prohibited to eat the food in the insulin spiked food group. In the passive phase, the user is able to eat the food in the insulin spiked food group in a controllable manner. In particular, the user is prohibited to eat low-carbohydrate diet in either the active phase or the passive phase. Preferably, a time period of the active phase is not shorter than a time period of the passive phase.

According to the preferred embodiment, the active phase is set up to 4 months. During the active phase, the user will eat the foods in the insulin non-spiked food group as much as the user wants to bring down the insulin level. As a result, the user will lose fat. The target weight to be lost during the active phase is about 10-15% of the body weight. It is worth mentioning that the user should not cheat during the active phase, wherein one time cheating (foods in the “Red Light” group) will spike up the insulin level.

The passive phase is set up to 3 months after the active phase. During the passive phase, the insulin level of the user will slowly bring up. In addition, the user has to cheat (systematic and slowly) during the passive phase, for example, by introducing half portion of enjoyment foods (“Red Light” group) every week. Therefore, it is totally different from other conventional weight loss programs that the user has to “diet” forever. Preferably, the insulin level of the user should increases 50% during the passive phase from the active phase.

Through the active-passive phase, the user is able to maintain the weight. The only way to maintain the weight is to eat in such a way that you feel comfortable. By eating the high GI carbohydrate (enjoyment foods in the “Red Light” group) again, the user almost goes back to his or her regular diet. That's why the user can maintain the weight.

Preferably, the user should test the insulin level before and after the predetermined weight losing time period. For example, the user can measure the insulin level before the active phase, after the active phase, and after the passive phase, wherein the results can be recorded in the control center 10.

The control center 10 will set the weight losing time period and will remain the user for the active-passive phase. During the active phase, the control center 10 will remain the user to eat the foods in the insulin non-spiked food group. During the passive phase, the control center 10 will remain the user to eat the foods in the insulin non-spiked food group and to controllably eat the foods in insulin spiked food group. The control center 10 will record all the foods taken by the user during the active-passive phase through the input of the user. As it is mentioned above, the body will begin to burn fat because the insulin level is high enough for the user to lower it again when the user goes back to the Active Phase of weight loss. Therefore, the user is able to repeat the active phase again after the passive phase is completed.

It is worth mentioning that the online platform 11 also serves as a communication platform for the user to post comments, recommendations, and picture for sharing the experience of the program of the present invention.

Furthermore, the present invention teaches the user how to apply biological principles of insulin to burn fat and lose weight; psychological principles of cognitive behavioral therapy (CBT) to change your thinking; and social behavioral techniques to break bad habits. Cognitive behavioral therapy (CBT) is a goal-oriented psychotherapy treatment that involves exposing the negative or inaccurate thinking and takes practical approach to problem-solving, so that the user can change the way he or she feels. CBT has been shown to be effective for addressing depression and some other disorders.

Accordingly, the participants are generally classified into two groups, i.e.

newcomer participants and consultant participants. Professional staffs also work with the system of the present invention. All the new registered users are grouped as the newcomer participants, and the newcomer participants can become the consultant participants when they finish the program, i.e. at least the active-passive phase.

The system of the present invention further comprises an assigning database 30 assigning one of consultant participants to supervise one or more of the newcomer participants. In particular, one of the consultant participants will be assigned to supervise one or more of the newcomer participants to help them to stay and finish the program. It is worth mentioning that all the newcomer participants and consultant participants are able to login the online platform 11 for accessing the teaching database 20. Once the newcomer participants become the consultant participants, higher education materials are available. All participants enter their information, weekly weight, pictures of themselves (optional), pictures of their foods, dietary log, etc, so that the consultant participants can monitor and supervise them correctly.

In particular, the newcomer participants are set at the first level of the system. For example, there is free entry with coupons/special promotion or with minimal cost for the newcomer participants. There is an online access to the training program for the newcomer participants to learn basic concepts of the present invention to lose weight. Also, online information inputs (weight, daily meal tracker, pictures of foods eating, etc. . . . ) are required so that the professional staffs can guide them to do the program correctly. It is worth mentioning that the newcomer participants are also supervised by the consultant participants in a live manner.

The consultant participants are set at the second level of the system. For example, the consultant participants will pay monthly membership fee. There is an online access to the training program for the consultant participants to learn the concepts with emphasis on cognitive behavioral therapy and behavior modification. Also, an online information inputs (weight, daily meal tracker, pictures of foods eating, etc. . . . ) are required so that profession staffs can guide them to do the program correctly. There are discount on supplement products and packages (appetite suppression, meal replacement, herbal products, etc. . . . ). For example, the consultant participants will learn the teaching materials utilizing the CBT technique in all teaching videos, reading materials, lectures, on-line coaching, mentoring, etc. . . . .

The system of the present invention further provide a free personalized website for the consultant participants, psychological evaluation to assess strengths and weakness, discount with exercise program, spas, gyms, fitness, yoga, etc. . . . . The consultant participants can also earn commission/profits for sales of supplement products and packages. Preferably, the system will issue a certified diploma for the consultant participants.

Accordingly, the personalized website for the consultant participant is the website that the consultant participant can upload his or her own personal information to promote his or her own business. For example, a travel agent who joins the program of the present invention and become the consultant participant. He or she can promote airfare, travel programs, etc. . . . on the own personalized website, which would link with social media such as “Facebook” account to his or her friends and social networks.

It is worth mentioning that it is an obligation for the consultant participants to supervise the newcomer participants at the first level, and to learn and follow the instruction from the professional staffs so that the consultant participants can supervise the newcomer participants correctly.

The system further provides a third level (effective level) for the consultant participants who need extra helps or want to go beyond. They are entitled to all the benefits of the first level plus any of the following extra packages. The consultant participants will receive a diploma of health educator certified by USA Academy of Health Sciences. With this diploma, they may be employed or in partnership with the system of the present invention. The consultant participants will obtain personalized session of Behavioral Therapy, personalized session of Cognitive Behavioral Therapy, monthly family meeting, special training for personal chef or cook, individual treatment plan with medical doctors, and/or become franchisee for the system of the present invention.

As it is mentioned above, the present invention further provides a weight control package. Some users may not able to accurately determine which group the food belonging to. The weight control package will ensure the users to stay and follow the program of the present invention. Accordingly, the weight control package comprises a bring down insulin level meal replacement, a bring up insulin level mean replacement, and supplement of appetite suppressor.

The bring down insulin level meal replacement comprises food compositions belonging to the insulin non-spiked food group, wherein the food compositions in said insulin non-spiked food group do not spike the insulin level of the user. In other words, the food compositions in the insulin non-spiked food group are selected from a group consisting of proteins and green, leafy vegetables that the user is able to eat said food compositions in the insulin non-spiked food group as much as the user wants and anytime the user wants for the weight losing time period.

The bring up insulin level mean replacement comprises food compositions belonging to the insulin spiked food group, wherein the food compositions in said insulin non-spiked food group is arranged for spiking the insulin level of the user. In other words, the food compositions in the insulin spiked food group are selected from a group consisting of sweets, grains, and starchy vegetables.

Accordingly, the user is able to take the bring down insulin level meal replacement during the active phase and to take the bring down insulin level meal replacement during the passive phase. In particular, the user is able to take the bring down insulin level meal replacement and the bring down insulin level meal replacement during the passive phase. The food compositions in the bring down insulin level meal replacement and the bring up insulin level mean replacement are individual packs, wherein the user is able to open each pack for one meal. For example, the food compositions in each pack can be in form of powder and can be dissolved in water.

It is worth mentioning that the eating guidance is included in the package and is downloadable to the electronic device of the user. The package further comprises an insulin level tester for the user to test the insulin level at home. Also, the consultant participants can earn profits from the sales of the packages from the other consultant participants or newcomer participants that they are supervising or used to supervise. For example, the consultant participants can earn profits by the sales of the packages linked to their free personalized website.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of weight control by monitoring and controlling an insulin level of a user, comprising the steps of:
(a) providing an insulin food guidance that categorizes different foods into an insulin spiked food group and an insulin non-spiked food group, wherein the foods in said insulin spiked food group spikes the insulin level of the user and the food in said insulin non-spiked food group do not spike the insulin level of the user; and
(b) providing an eating guidance for the user to eat the food in said insulin non-spiked food group and not to eat the food in said insulin spiked food group for a predetermined weight losing time period.

2. The method, as recited in claim 1, wherein the foods in said insulin non-spiked food group are selected from a group consisting of proteins and green, leafy vegetables that the user is able to eat the food in said insulin non-spiked food group as much as the user wants and anytime the user wants.

3. The method, as recited in claim 2, wherein the foods in said insulin spiked food group are selected from a group consisting of sweets, grains, and starchy vegetables.

4. The method, as recited in claim 3, wherein said insulin food guidance further categorizes an insulin caution food group that foods in said insulin caution food group spike the insulin level of the user when the user eats more than one total portion per day, wherein the foods in said insulin caution food group are selected from a group consisting of fruits and raw nuts.

5. The method, as recited in claim 1, further comprising a step of:
(c) configuring said weight losing time period into an active phase and a passive phase, wherein in said active phase, the user is prohibited to eat the food in said insulin spiked food group, and in said passive phase, the user is able to eat the food in said insulin spiked food group in a controllable manner.

6. The method, as recited in claim 5, wherein a time period of said active phase is not shorter than a time period of said passive phase.

7. The method, as recited in claim 5, wherein said active phase is defined as a period that the insulin level of the user is brought down, and said passive phase is defined as a period that the insulin level of the user is slowly brought up after said active phase.

8. The method, as recited in claim 5, further comprising a step of repeating said active phase again after said passive phase is completed.

9. The method, as recited in claim 1, further comprising a step of providing an online platform for the user to post comments, recommendations, and picture for sharing.

10. The method, as recited in claim 1, wherein said eating guidance is downloadable to an electronic device of the user.

11. The method, as recited in claim 1, further comprising a step of testing the insulin level of the user before and after the predetermined weight losing time period.

12. A weight control package, comprising:
a bring down insulin level meal replacement which comprises food compositions belonging to an insulin non-spiked food group, wherein said food compositions in said insulin non-spiked food group do not spike an insulin level of a user, wherein said food compositions in said insulin non-spiked food group are selected from a group consisting of proteins and green, leafy vegetables that the user is able to eat said food compositions in said insulin non-spiked food group as much as the user wants and anytime the user wants for a predetermined weight losing time period.

13. The weight control package, as recited in claim 12, further comprising a bring up insulin level mean replacement which comprises food compositions belonging to an insulin spiked food group, wherein said food compositions in said insulin non-spiked food group is arranged for spiking the insulin level of the user, wherein said food compositions in said insulin spiked food group are selected from a group consisting of sweets, grains, and starchy vegetables.

14. The weight control package, as recited in claim 13, further comprising a an eating guidance for the user to eat, wherein said eating guidance is a guidance to configure said weight losing time period into an active phase and a passive phase, wherein said bring down insulin level meal replacement is consumed during said active phase and said bring up insulin level meal replacement is consumed during said passive phase.

15. The weight control package, as recited in claim 14, wherein said active phase is defined as a period that the insulin level of the user is brought down, and said passive phase is defined as a period that the insulin level of the user is slowly brought up after said active phase.

16. The weight control package, as recited in claim 14, wherein said eating guidance is downloadable to an electronic device of the user.

17. The weight control package, as recited in claim 12, further comprising a supplement of appetite suppressor.

18. A weight control system, comprising:
a control center which comprises an online platform for different users as participants accessing through Internet; and
a teaching database provided on said online platform, wherein said teaching database includes an insulin food guidance that categorizes different foods into an insulin spiked food group and an insulin non-spiked food group, and an eating guidance for the user to eat the food in said insulin non-spiked food group and not to eat the food in said insulin spiked food group for a predetermined weight losing time period, wherein the foods in said insulin spiked food group spikes the insulin level of the user and the food in said insulin non-spiked food group do not spike the insulin level of the user.

19. The weight control system, as recited in claim 18, wherein said eating guidance is downloadable to an electronic device of the user.

20. The weight control system, as recited in claim 18, further comprising an assigning database assigning one of consultant participants to supervise one or more of newcomer participants.
